(19) United States
(12) Patent Application Publication
(10) Pub. No.: US 2005/0032930 A1
(43) Pub. Date: Feb. 10, 2005

(54) Inkjet ink

(76) Inventor: Christian Jackson, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/878,578

(22) Filed: Jun. 28, 2004

Related U.S. Application Data
(60) Provisional application No. 60/484,384, filed on Jul. 2, 2003.

(51) Int. Cl. C03C 17/00; C09D 11/00

(52) U.S. Cl. 523/160; 523/161

(57) ABSTRACT

This invention pertains to an ink for inkjet printing, in particular to an aqueous ink comprising a self-dispersing pigment colorant and a hydrosol polymer to improve image fastness.

### CROSS-REFERENCE TO RELATED APPLICATIONS

This application claims priority under 35 U.S.C. §119 from U.S. Provisional Application Ser. No. 60/484,384 (filed Jul. 2, 2003), the disclosure of which is incorporated by reference herein for all purposes as if fully set forth.

### BACKGROUND OF THE INVENTION

This invention pertains to an inkjet ink, in particular to an aqueous inkjet ink comprising self-dispersible pigment and hydrosol polymer to improve image fastness.

Inkjet printing is a non-impact printing process in which droplets of ink are deposited on print media, such as paper, to form the desired image. The droplets are ejected from a printhead in response to electrical signals generated by a microprocessor.

Both dyes and pigments have been used as colorants for inkjet inks. While dyes are typically easier to formulate compared to pigments, they tend to fade quickly and are more prone to rub off. Inks comprising pigments dispersed in aqueous media are advantageously superior to inks using water-soluble dyes in water-fastness and light-fastness of printed images.

Pigments suitable for aqueous inkjet inks are in general well-known in the art. Traditionally, pigments have been stabilized by dispersing agents, such as polymeric dispersants or surfactants, to produce a stable dispersion of the pigment in the vehicle. More recently though, so-called “self-dispersible” or “self-dispersing” pigments (hereafter “SDP(s)”) have been developed. As the name would imply, SDPs are dispersible in water without dispersants.

SDPs are often advantageous over traditional dispersant-stabilized pigments from the standpoint of greater stability and lower viscosity at the same pigment loading. This can provide greater formulation latitude in final ink.

Prints made with SDP ink, however, tend to be susceptible to rub off and smear. EP-A-1 114851 demonstrates (Comparative Example 2 in Table 3) the problem of poor smear resistance in an SDP inkjet ink (therein referred to as rubbing/scratching resistance). There is taught the combination of SDP and dispersant stabilized pigment to improve image properties. EP-A-1158030 likewise demonstrates (Example 9 in Table 1) the problem of poor smear resistance with SDP inkjet ink (therein is referred to as high-lighter resistance).

Addition of polymer binder to improve print properties is often proposed. Ink with SDP and polymer are disclosed, for example, in U.S. Pat. No. 5,571,311, U.S. Pat. No. 5,630,868, U.S. Pat. No. 5,672,198, U.S. Pat. No. 6,057,384, U.S. Pat. No. 6,103,780, U.S. Pat. No. 6,329,446, US 20020147252, EP-A-1304364, EP-A-1146090 and EP-A-0894835.

All of the above-identified publications are incorporated by reference herein for all purposes as if fully set forth.

However, addition of polymer to improve image fastness of SDP inks usually causes lower optical density compared to ink without polymer. Optical density is a particularly important aspect of overall image quality and preferably SDP ink formulations can be made to improve image fastness without loss of optical density.

### SUMMARY OF THE INVENTION

It has been found that addition of a hydrosol polymer to an SDP ink improved fastness of the printed image without reducing optical density.

In accordance with these findings, the present invention pertains to an aqueous inkjet ink comprising a self-dispersing pigment colorant, an aqueous vehicle and a hydrosol polymer. Preferably, the hydrosol polymer is an acrylic hydrosol polymer.

In accordance with another aspect of the present invention, there is provided an ink set comprising at least three differently colored inks, wherein at least one of the inks is an aqueous inkjet ink as set forth above.

In yet another aspect of the present invention, there is provided a method for ink jet printing onto a substrate, comprising the steps of:

(a) providing an ink jet printer that is responsive to digital data signals;

(b) loading the printer with a substrate to be printed;

(c) loading the printer with an ink as set forth above and described in further detail below, or an ink jet ink set as set forth above and described in further detail below; and

(d) printing onto the substrate using the ink or inkjet ink set in response to the digital data signals.

It should be noted that use of hydrosol polymers in ink jet inks in conjunction with conventional pigment dispersions has generally been described in U.S. Pat. No. 6,232,369 (the disclosure of which is incorporated by reference herein for all purposes as if fully set forth). There is, however, no suggestion in this reference of the use of such hydrosol polymers in conjunction with SDPs, nor the surprising benefits of such use in the context of the present invention.

These and other features and advantages of the present invention will be more readily understood by those of ordinary skill in the art from a reading of the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise.

### DETAILED DESCRIPTION OF THE PREFERRED EMBODIMENTS

The present invention provides an SDP ink composition with improved fastness and high optical density. The composition comprises an SDP colorant, an aqueous vehicle and a hydrosol polymer, preferably an acrylic hydrosol polymer. The ink may optionally contain other additives and adjuvants well-known in the relevant art. The inks may be adapted to the requirements of a particular inkjet printer to provide an appropriate balance of properties such as, for instance, viscosity and surface tension.

Herein, reference to “fastness” generally means resistance to color removal including, for example, rub fastness (finger rub), water fastness (water drop) and smear fastness (highlighter pen stroke).

Colorant

The colorant in the inks of present invention comprises a pigment. By definition, pigments do not form (to a significant degree) a solution in the aqueous vehicle and must be dispersed.

The pigment colorants of the present invention are more specifically self-dispersing pigments. SDPs are surface modified with dispersibility imparting groups to allow stable dispersion without separate dispersant. For dispersion in aqueous vehicle, the surface modification involves addition of hydrophilic groups and most typically ionizable hydrophilic groups. See, for example, U.S. Pat. No. 5,554,739, U.S. Pat. No. 5,571,311, U.S. Pat. No. 5,609,671, U.S. Pat. No. 5,672,198, U.S. Pat. No. 5,698,016, U.S. Pat. No. 5,707,432, U.S. Pat. No. 5,718,746, U.S. Pat. No. 5,747,562, U.S. Pat. No. 5,749,950, U.S. Pat. No. 5,803,959, U.S. Pat. No. 5,837,045, U.S. Pat. No. 5,846,307, U.S. Pat. No. 5,851,280, U.S. Pat. No. 5,861,447, U.S. Pat. No. 5,885,335, U.S. Pat. No. 5,895,522, U.S. Pat. No. 5,922,118, U.S. Pat. No. 5,928,419, U.S. Pat. No. 5,976,233, U.S. Pat. No. 6,057,384, U.S. Pat. No. 6,099,632, U.S. Pat. No. 6,123,759, U.S. Pat. No. 6,153,001, U.S. Pat. No. 6,221,141, U.S. Pat. No. 6,221,142, U.S. Pat. No. 6,221,143, U.S. Pat. No. 6,277,183, U.S. Pat. No. 6,281,267, U.S. Pat. No. 6,329,446, U.S. Pat. No. 6,332,919, U.S. Pat. No. 6,375,317, US2001/0035110A1, US2002/0014184A1, EP-A-1086997, EP-A-1114851, EP-A-1158030, EP-A-1167471, EP-A-1122286, WO01/10963 and WO01/25340, the disclosures of which are incorporated by reference herein for all purposes as if fully set forth.

The SDP colorant can be further defined by its ionic character. Anionic SDP yields, in aqueous medium, particles with anionic surface charge. Conversely, cationic SDP yields, in aqueous medium, particles with cationic surface charge. Particle surface charge can be imparted, for example, by attaching groups with anionic or cationic moieties to the particle surface. The SDP of the present invention are preferably, although not necessarily, anionic.

Anionic moieties attached to the anionic SDP surface can be any suitable anionic moiety but are preferably (I) or (II):
—CO₂Z (I)
—SO₃Z (II)
wherein Z is selected from the group consisting of conjugate acids of organic bases; alkali metal ions; “onium” ions such as ammonium, phosphonium and sulfonium ions; and substituted “onium” ions such as tetraalkylammonium, tetraalkyl phosphonium and trialkyl sulfonium ions; or any other suitable cationic counterion. Useful anionic moieties also include phosphates and phosphonates. Most preferred are type I (“carboxylate”) anionic moieties.

Also preferred is a degree of functionalization wherein the density of hydrophilic groups is less than about 3.5 μmoles per square meter of pigment surface (3.5 μmol/m²), more preferably less than about 3.0 μmol/m². Degrees of functionaliztion of less than about 1.8 μmol/m², and even less than about 1.5 μmol/m², are also suitable and may be preferred for certain specific types of SDPs. As used above and otherwise herein, “degree of functionalization” refers to the amount of hydrophilic groups present on the surface of the SDP per unit surface area, measured in accordance with the method described further herein.

Carboxylated anionic SDP species include those described, for example, in previously incorporated U.S. Pat. No. 5,571,311, U.S. Pat. No. 5,609,671 and US2002/0014184A1; and, sulfonated (type II) SDPs include those described, for example, in previously incorporated U.S. Pat. No. 5,571,331, U.S. Pat. No. 5,928,419 and EP-A-1146090.

It is desirable to use small colorant particles for maximum color strength and good jetting. The particle size may generally be in the range of from about 0.005 to about 15 microns, is typically in the range of from about 0.005 to about 1 micron, is preferably from about 0.005 to about 0.5 microns, and is more preferably in the range of from about 0.01 to about 0.3 microns.

The levels of SDPs employed in the instant inks are those levels that are typically needed to impart the desired optical density to the printed image. Typically, SDP levels are in the range of about 0.01 to about 10% by weight of the ink.

The SDPs may be black, such as those based on carbon black, or may be colored pigments such as those based on PB 15:3 and 15:4 cyan, PR 122 and 123 magenta, and PY 128 and 74 yellow.

The SDPs may be prepared by grafting a functional group or a molecule containing a functional group onto the surface of the pigment, or by physical treatment (such as vacuum plasma), or by chemical treatment (for example, oxidation with ozone, hypochlorous acid or the like). A single type or a plurality of types of hydrophilic functional groups may be bonded to one pigment particle. The type and degree of functionalization may be properly determined by taking into consideration, for example, dispersion stability in ink, color density, and drying properties at the front end of an ink jet head. Further details may be found by reference to the numerous publications incorporated above.

In one preferred embodiment, the hydrophilic functional group(s) on the SDP are primarily carboxyl groups, or a combination of carboxyl and hydroxyl groups; even more preferably the hydrophilic functional groups on the SDP are directly attached and are primarily carboxyl groups, or a combination of carboxyl and hydroxyl.

Preferred pigments in which the hydrophilic functional group(s) are directly attached may be produced, for example, by a method described in previously incorporated US2002/0014184A1. Carbon black treated by the method described in this publication has a high surface-active hydrogen content, which is neutralized with base to provide very stable dispersions in water. Application of this method to colored pigments is also possible.

In a preferred embodiment, the colorant in ink of the present invention comprises only SDP.

Vehicle

“Aqueous vehicle” refers to water or a mixture of water and at least one water-soluble organic solvent (co-solvent). Selection of a suitable mixture depends on requirements of the specific application, such as desired surface tension and viscosity, the selected colorant, drying time of the ink, and the type of substrate onto which the ink will be printed. Representative examples of water-soluble organic solvents that may be selected are disclosed in U.S. Pat. No. 5,085,698 (the disclosure of which is incorporated by reference herein for all purposes as if fully set forth).

If a mixture of water and a water-soluble solvent is used, the aqueous vehicle typically will contain about 30% to about 95% water with the balance (i.e., about 70% to about 5%) being the water-soluble solvent. Preferred compositions contain about 60% to about 95% water, based on the total weight of the aqueous vehicle.

The amount of aqueous vehicle in the ink is typically in the range of about 70% to about 99.8%, and preferably about 80% to about 99.8%, based on total weight of the ink.

The aqueous vehicle can be made to be fast penetrating (rapid drying) by including surfactants or penetrating agents such as glycol ethers and 1,2-alkanediols. Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether. 1,2-Alkanediols are preferably 1,2-C4-6 alkanediols, most preferably 1,2-hexanediol. Suitable surfactants include ethoxylated acetylene diols (e.g. Surfynols® series from Air Products), ethoxylated primary (e.g. Neodol® series from Shell) and secondary (e.g. Tergitol® series from Union Carbide) alcohols, sulfosuccinates (e.g. Aerosol® series from Cytec), organosilicones (e.g. Silwet® series from Witco) and fluoro surfactants (e.g. Zonyl® series from DuPont).

The amount of glycol ether(s) and 1,2-alkanediol(s) added must be properly determined, but is typically in the range of from about 1 to about 15% by weight and more typically about 2 to about 10% by weight, based on the total weight of the ink. Surfactants may be used, typically in the amount of about 0.01 to about 5% and preferably about 0.2 to about 2%, based on the total weight of the ink.

Hydrosol Polymer

The hydrosol polymers are water-insoluble polymers initially synthesized in organic solvent and then dispersed as a separate phase in the aqueous carrier medium. Primarily, the hydrosol polymers will contain hydrophobic non-functional monomers to adjust the polymer properties for optimal smear resistance without sacrificing other ink properties, such as pigment dispersion stability, water fastness, viscosity, surface tension, etc. Monomers that are particularly useful for this purpose include methyl acrylate, ethyl acrylate, propyl acrylate, n-butyl acrylate, hexyl acrylate, 2-ethylhexyl acrylate, phenyl acrylate, benzyl acrylate, 2-phenylethyl acrylate, hydroxyethylacrylate, methyl methacrylate, ethyl methacrylate, propyl methacrylate, n-butyl methacrylate, hexyl methacrylate, 2-ethylhexyl methacrylate, phenyl methacrylate, benzyl methacrylate, 2-phenylethyl methacrylate, hydroxyethyl methacrylate, and the like. Low levels of non-acrylic monomers may be incorporated to improve physical properties of the polymer. Useful examples include styrene, a-methyl styrene, vinyl naphthalene, vinylidene chloride, vinyl acetate, vinyl chloride, acrylonitrile, and the like.

Preferably, the hydrosols will contain functional groups that will self-stabilize the hydrosol in the aqueous medium. These functional groups are characterized by their solubility in aqueous medium and can be non-ionic (e.g., polyethylene oxide groups), anionic (e.g., carboxyl groups, sulfonic acid groups), or cationic (e.g., ammonium groups) hydrosols. Accordingly, the hydrosols can be designed to carry either an anionic charge or cationic charge or no charge to suit the application. If ionic, the charge will preferably be the same as the charge on the SDP.

The amount of the functional groups required to stabilize the hydrosol depends on the composition of the polymer and the molecular weight of the polymer. The amount of functional groups needs to be high enough to provide the stability throughout the life of the ink, yet if the hydrosol contains too many of these groups, it will become completely soluble in the aqueous medium and the improved smear resistance of the inks will be diminished. Usually, a more hydrophilic polymer composition will require less functional groups. A polymer of lower molecular weight may require more functional groups to ensure the distribution of them on all polymer chains.

The amount of the hydrophilic polyethylene oxide containing monomers are used to control the hydrophilicity of the hydrosol polymer as a whole. In general, the anionic monomers are used in an amount of about 0.5 to about 10%, preferably about 1 to about 5%, by weight based on the total weight of the polymer for the anionic hydrosols. The cationic monomers are used in an amount of about 2 to about 20%, preferably about 5 to about 15%, by weight based on the total weight of the polymer for the cationic hydrosols.

The functional groups are usually incorporated into the polymer structure by copolymerizing monomers that contain such groups. Examples of useful monomers containing the non-ionic hydrophilic ethylene oxide groups include 2-(2-methoxyethoxy)ethyl acrylate, 2-(2-methoxyethoxy)ethyl methacrylate, ethoxytriethyleneglycol methacrylate, methoxy polyethyleneglycol (molecular weight of 200-100o) monomethacrylate, polyethyleneglycol (molecular weight 200-1000) monomethacrylate, and the like. Examples of useful monomers containing the ionizable groups for anionic hydrosols include acrylic acid, methacrylic acid, crotonic acid, itaconic acid, itaconic acid monoester, maleic acid, maleic acid mono-ester, maleic anhydride, fumaric acid, fumaric acid monoester, styrene sulfonic acid, 2-acrylamido-2-propane sulfonic acid (AMPS), and the like. For cationic hydrosols, the preferred ionizable monomers are amine-containing monomers. The amine groups may be primary, secondary or tertiary amine groups, or mixtures thereof. Examples of amine-containing monomers include N,N-dimethylaminoethyl acrylate, N,N-dimethylaminoethyl methacrylate, N,N-diethylaminoethyl methacrylate, t-butylaminoethyl methacrylate, 2-N-morpholinoethyl acrylate, 2-N-morpholinoethyl metharylate, 4-aminostyrene, 2-vinylpyridine, 4-vinylpyridine, and the like.

To further enhance the hydrosol stability, the polymer may contain up to about 5%, preferably up to about 2.0% by weight, based on the weight of the hydrosol polymer, of surface-active monomers. The surface-active monomers may be nonionic, such as SAM 185 (HLB=6.9), SAM 186 (HLB=9.9), and SAM 187 (HLB=14.0) (PPG-MAZER, Chemicals Group Technical Centers, PPG Industries, Inc., Monroeville, Pa.), which are characterized by the following general formula: Polymerizable Group (Allyl)-hydrophobe-(OCH₂CH₂)n—OH.

The surface active monomers may also be ionic, such as TREM LF-40, a 40% solution of the sodium salt of ally dodecyl sulfosuccinate supplied by Henkel Chemical Corp. (Ambler, Pa.). Mixtures of the nonionic type and the ionic type can be advantageously employed for additional stabilization effect. It is important that the charge characteristics of the ionic surface-active monomers are compatible with the charge characteristics of the hydrosol polymer.

To invert the hydrosol polymer into the aqueous carrier medium, it may be necessary to ionize the functional groups on the hydrosol polymer in an aqueous solution under vigorous agitation. For hydrosols containing anionic functional groups, the groups are neutralized/ionized with bases, such as alkali metal hydroxides, alkali metal carbonate and bicarbonate, organic amines (mono-, di-, tri-methylamine, morpholine, N-methylmorpholine), organic alcohol amines (N,N-dimethylethanolamine, N-methyl diethanolamine, mono-, di-, tri-ethanolamine), ammonium salts (ammonium hydroxide, tetra-alkyl ammonium hydroxide), and pyridine. For hydrosols containing cationic groups, the groups are neutralized/ionized with acids, such as organic acid (acetic acid, propionic acid, formic acid, oxalic acid), hydroxylated acids (glycolic acid, lactic acid), halogenated acids (hydrochloric acid, hydrobromic acid), and inorganic acids (sulfuric acid, phosphoric acid, nitric acid). The cationic groups can also be prepared by converting the amine groups to tetraalkyl ammonium salt by using alkylating agents such as methyl iodide, methyl bromide, benzyl chloride, methyl p-toluene sulfonate, ethyl p-toluene sulfonate, dimethyl sulfate, and the like.

The size of the polymeric particles of the hydrosol in the finished inks depends on the polymer composition and the aqueous carrier medium. The more hydrophilic compositions tend to be swollen by the aqueous medium easily to give particles having a large size, while the hydrophobic compositions tend to give particles having size of less than about 0.5 micron.

The hydrosols may be either linear or graft or branched polymers. The linear acrylic hydrosol polymers can be conveniently prepared by those skilled in the art using the conventional free radical solution polymerization process. Useful examples of initiators include benzoyl peroxide, hydrogen peroxide and other peroxy compounds such as t-butyl peroxypivalate, t-butyl peracetate, t-butyl peroctoate, and azo compounds such as azoisobutyronitrile, and the Vazo® initiators that are commercially available from the DuPont Company (Wilmington, Del.). The solvent used for the polymerization is preferably miscible with water so that the polymer can be conveniently inverted. Alternatively, the solvents can be displaced with a water-miscible solvent after the polymerization step is completed and before the inversion step. Examples of useful solvents include alcohols such as methanol, ethanol, n-propanol, isopropanol, ketones such acetone, methyl ethyl ketone, acetates such as ethyl acetate, butyl acetate, glycol ethers such as ethylene glycol monobutyl ether, ethylene glycol monobutyl ether acetate, propylene glycol monomethyl ether, pyrrolidones such as 2-pyrrolidone, N-methyl pyrrolidone, and the mixtures thereof. The molecular weight of the polymer can be controlled by the conventional methods of adding a chain transfer agent such as a mercaptan. The resulting polymers that are useful for practicing the invention have a weight averaged molecular weight (M_{w}) preferably in the range of about 4,000 to about 150,000, more preferably in the range of about 4,500 to about 100,000.

For the hydrosols having a graft or a branched structure, the stabilizing groups may be concentrated either on the backbone or in the arms. With such arrangement, excellent hydrosol stability can be obtained with fewer of stabilizing groups, and thus the resulting inks exhibit greater resistance to smear/smudge and general attack of humidity. The graft polymers are most conveniently prepared by the macromonomer approach as described in U.S. Pat. No. 5,231,131 (the disclosure of which is incorporated by reference herein for all purposes as if fully set forth). A macromonomer containing selected monomers, either predominantly monomers with the hydrophilic stabilizing groups or the hydrophobic monomers, may be prepared by methods suggested in Unexamined Japanese Patent Application (Kokai) No. 6-100,810, where conventional organic chemistries are employed to build the terminal polymerizable double bond in a polymer, or by methods suggested by previously incorporated U.S. Pat. No. 5,231,131, where a special chain-transfer agent like cobalt complexes are employed. The macromonomers are then copolymerized with the remaining monomers and become the arms or branches of the graft copolymer.

The hydrosol polymer may be present in the ink in an “effective amount” to improve smear resistance without impeding the pen reliability, as compared to an ink without the hydrosol polymer. Typically, the hydrosol polymer will be present in an amount of about 0.1 to about 20% by weight (solids), preferably about 0.5 to about 10% by weight, based on the total weight of the ink composition.

Further details on suitable hydrosol polymers can be found by reference to previously incorporated U.S. Pat. No. 6,232,369.

Other Ingredients

Other ingredients may be formulated into the inkjet ink, to the extent that such other ingredients do not interfere with the stability and jetablity of the ink, which may be readily determined by routine experimentation. Such other ingredients are in a general sense well known in the art.

Biocides may be used to inhibit growth of microorganisms.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

The ink may optionally contain one or more soluble polymer(s), especially soluble structured polymers. Soluble means dissolved in the aqueous vehicle. The term “structured polymer” means polymers having a block, branched or graft structure. Especially preferred are AB or BAB block copolymers such as those disclosed in U.S. Pat. No. 5,085,698, ABC block copolymers such as those disclosed in U.S. Pat. No. 5,519,085 and graft polymers such as those disclosed in U.S. Pat. No. 5,231,131. The disclosures of these three references are incorporated by reference herein for all purposes as if fully set forth. If present, these soluble polymers are dissolved in the vehicle and do not serve as a “dispersant”, per se.

Preferably, the number average molecular weight (Mₙ) of any soluble polymer present is in the range of about 1,000 to about 20,000, more preferably about 1,000 to about 10,000, and most preferably about 2,000 to about 6,000. Soluble polymers are preferably comprised of ionic monomers, preferably anionic monomers with ionizable acid groups. The preferred acid content is between about 0.65 and about 6 milliequivalents per gram of polymer, and the most preferred being between about 0.90 and about 1.75 milliequivalents per gram of polymer. All polymers may also contain monomers that have hydrophilic groups including, but not limited to, hydroxyls, amides, and ethers.

The optional soluble polymer can be employed at levels, based on the final weight of ink, of about 0.1% or more, and preferably about 0.25% or more (solids). Upper limits are dictated by ink viscosity or other physical limitations, but are generally about 2% or less.

Ink Properties

Jet velocity, separation length of the droplets, drop size and stream stability are greatly affected by the surface tension and the viscosity of the ink. Pigmented ink jet inks typically have a surface tension in the range of about 20 dyne/cm to about 70 dyne/cm at 25° C. Viscosity can be as high as 30 cP at 25° C., but is typically somewhat lower. The ink has physical properties compatible with a wide range of ejecting conditions, i.e., driving frequency of the piezo element, or ejection conditions for a thermal head, for either a drop-on-demand device or a continuous device, and the shape and size of the nozzle. The inks should have excellent storage stability for long periods so as not clog to a significant extent in an ink jet apparatus. Further, the ink should not corrode parts of the ink jet printing device it comes in contact with, and it should be essentially odorless and non-toxic.

Although not restricted to any particular viscosity range or printhead, the inventive ink set is particularly suited to lower viscosity applications such as those required by thermal printheads. Thus the viscosity (at 25° C.) of the inventive inks and fixer can be less than about 7 cps, is preferably less than about 5 cps, and most advantageously is less than about 3.5 cps. Thermal inkjet actuators rely on instantaneous heating/bubble formation to eject ink drops and this mechanism of drop formation generally requires inks of lower viscosity.

Ink Sets

The ink sets in accordance with the present invention preferably comprise at least three differently colored inks (such as CMY), and preferably at least four differently colored inks (such as CMYK), wherein at least one of the inks is an aqueous inkjet ink comprising:

(a) an SDP colorant;

(b) an aqueous vehicle; and

(c) a hydrosol polymer

as set forth above.

As indicated above, preferably the ink set comprises at least 4 different colored inks (CMYK), wherein the black (K) ink comprises:

(a) a black SDP colorant;

(b) an aqueous vehicle; and

(c) a hydrosol polymer

as set forth above.

The other inks of the ink set are preferably also aqueous inks, and may contain dyes, pigments or combinations thereof as the colorant. Such other inks are, in a general sense, well known to those of ordinary skill in the art.

Substrate

The instant invention is particularly advantageous for printing on plain paper such as common electrophotographic copier paper.

### EXAMPLES

Dispersion 1

Carbon black (S-160 from Degussa, surface area 150 m²/g) was oxidized with ozone according to the process described in previously incorporated US2002/0014184A1 and neutralized with LiOH. After recovery, a 16.6 weight percent dispersion of self-dispersing carbon black pigment in water was obtained with a viscosity of 3.5 cps (25° C.). The median particle size was 110 nm and the acid number (degree of functionalization) was 3.3 μmol/m². The degree of functionalization, as measured, was slightly above the target level of <3.0 μmol/m².

The degree of functionalization (acid value) of this SDP (and others in these examples made by the process according to US2002/0014184A1) was determined by the equivalent moles of base required to neutralize the treated pigment to a pH of 7. As the surface hydrophilic groups are substantially all acidic, the acid value also equals the degree of functionalization.

Equivalent moles of base can be determined by titration or, in the case of inorganic bases such as alkali metal hydroxides, by atomic absorption (AA) or Inductive Coupled Plasma (ICP) analysis. Moles of base per gram of SDP is obtained and converted to μmol/m² by dividing by the surface area of the pigment and adjusting the units appropriately. For accuracy, the neutralized sample must be free of contaminants, such as free acids or salts, which would interfere with the measurement.

Preparation of Soluble Polymer Binder 1 (Comparative)

A 3-liter flask was equipped with a mechanical stirrer, thermocouple, N₂ inlet, condenser, drop funnel and syringe pump. Tetrahydrofuran (950 g), 1,1-bis(trimethylsiloxy) 2-methyl propene (46.2 g) and tetrabutylammonium m-chlorobenzoate (2 g) were added into pot. Feed I (tetrahydrofuran (5 g) and tetrabutylammonium m-chlorobenzoate (0.8 g)) and Feed II (benzyl methacrylate (600 g), 2-(trimethylsiloxy)ethyl methacrylate (312 g), ethyltriethyleneglycol methacrylate (100 g) and trimethylsilyl methacrylate (152 g)) were started at time 0 minutes. Feed I was added over 200 minutes. Feed II was added over 60 minutes. After 360 minutes 90 g of methanol was added to the pot. The pot was heated to reflux and 500 g were distilled. A solution of water (124 g) and di-chloroacetic acid (0.2 g) was added to the pot and refluxed for 60 minutes. After refluxing, 725 g were distilled and 2-pyrrolidinone (889 g) was added. This synthesis produced a random acrylic polymer of 60 wt % benzyl methacrylate, 20 wt % 2-hydroxyethyl methacrylate, 10 wt % ethyltriethyleneglycol methacrylate and 10 wt % methacrylic acid at a Mₙ of 5300. The solution contained 52% polymer solids in 2-pyrrolidone.

The polymer solution in 2-pyrrolidone was diluted with deionized water and neutralized to 80% with potassium hydroxide to make a 15% polymer solids aqueous solution.

Preparation of Hydrosol 1

A 3-liter flask was equipped with a mechanical stirrer, thermometer, N₂ inlet, drying tube outlet and addition funnels. Tetrahydrofuran (THF) (1200 g) was charged to the flask. The tetrabutyl ammonium m-chlorobenzoate (catalyst, 0.75 ml of a 1.0 M solution in acetonitrile) was then added. 1,1-bis(trimethylsilyloxy)-2-methyl propene (initiator, 42.5 g (0.18 moles)) was injected. Feed 1 (tetrabutyl ammonium m-chlorobenzoate (0.4 ml of a 1.0 M solution in acetonitrile) and THF (5 g)) was started and added over 180 minutes. Feed 2 (trimethylsilyl methacrylate (135.5 g (0.86 moles)) and benzyl methacrylate (825.5 g (4.69 moles))) was started at 0.0 minutes and added over 45 minutes. At 125 minutes, 70 g of methanol was added to the above solution and distillation begun. During the first stage of distillation, 375 g of material was removed. The final polymer was 48.5 % solids and had a composition of 90/10 benzyl methacrylate/methacrylic acid; a molecular weight, Mn, of 4995; and an acid value of 1.22 (milliequivalents/gram of polymer solids) based on total solids.

The solvent was then exchanged by taking, in a 2-liter flask, 1000 g of polymer solution and heating to reflux to distill off 284 g of solvent. Then, 221 g of 2-pyrrolidone was added to the flask. Another 156 g of solvent was distilled off and 266 g of 2-pyrrolidone was added to make a polymer solution with 47% solids and 2-pyrrolidone as the primary solvent.

Hydrosol 1 as an aqueous dispersion was prepared by mixing 319 g of this 2-pyrrolidone polymer solution with 18.25 g of a 45% potassium hydroxide solution and 663 g of deionized water. The polymer was dispersed by mixing with a Red Devil Speed Demon Mixer (Red Devil Equipment Co., Union, New Jersey) for 45 minutes.

Preparation of Hydrosol 2

Hydrosol 2 was prepared in the same manner as Hydrosol 1 except the monomer ratio was altered. As before, the final polymer was obtained as a solution in 2-pyrrolidone. The polymer content was 48.4% solids and had a composition of 92/8 benzyl methacrylate/methacrylic acid, a molecular weight, Mn, of 4999 and an acid value of 0.98 (milliequivalents/gram of polymer solids) based on total solids.

Hydrosol 2 as an aqueous dispersion was prepared by mixing 310 g of this 2-pyrrolidone polymer solution with 14.7 g of a 45% potassium hydroxide solution and 675 g of deionized water. The polymer was dispersed by mixing with a Red Devil Speed Demon Mixer (Red Devil Equipment Co., Union, New Jersey) for 45 minutes.

Measurement of Smear

A series of 4 mm-wide stripes were printed onto a test page. To determine smear, two strokes from a highlighter, one on top of the other, were drawn across the stripes. This process was carried out on different parts of the test pattern at 10 sec and 10 minutes after printing. The optical density of the ink smeared into the blank paper portion between the lines was measured. If there was no smear this value was zero; a higher optical density indicated more colorant was displaced and therefore the smear fastness was worse. Suitable highlighter pens are available, for example, under the trademarks Hi-Liter® Highlighting Marker (referred to as an ‘acidic’ marker because the acidic pH) and Hi-Liter® Fluorescent Marker (referred to a ‘basic’ marker because the basic pH) from Avery Dennison Corp.

### Example 1

The optical density performance of the inventive inks containing hydrosol polymer was compared to similar ink without such polymer and to ink containing a soluble polymer.

The inks were prepared according to the recipes shown in the following table. Values are in weight percent of the final weight. Pigment was added as the dispersion.

| | Ink Formulation | | | | |
|---|---|---|---|---|---|
| Ingredients | Ink A* | Ink 1 | Ink 2 | Ink D* | Ink E* |
| Dispersion 1 (as % pigment) | 3.0 | 3.0 | 3.0 | 3.5 | 3.5 |
| 1,2-hexanediol | 4.0 | 4.0 | 4.0 | 4.0 | 4.0 |
| Glycerol | 10.0 | 10.0 | 10.0 | 15.0 | 15.0 |
| Ethylene glycol | 5.0 | 5.0 | 5.0 | 1.0 | 1.0 |
| 2-pyrrolidone | 3.0 | 3.0 | 3.0 | 3.0 | 3.0 |
| Surfynol ® 465 (Air | 0.2 | 0.2 | 0.2 | 0.2 | 0.2 |
| Products Corp., | | | | | |
| Allentown PA, USA) | | | | | |
| Triethanolamine | — | — | — | — | 0.2 |
| Hydrosol 1 (as % polymer) | — | 0.75 | 1.5 | — | — |
| Soluble Binder 1 | — | — | — | — | 1.0 |
| (as % polymer) | | | | | |
| Water (balance to 100%) | bal | bal | bal | bal | bal |

*Comparative Examples

The inks were printed using an Epson 980 Stylus Color printer (Seiko Epson Corporation). Optical density was measured with a Greytag-Macbeth SpectroEye (Greytag-Macbeth AG, Regensdorf, Switzerland). Papers used as substrate in print tests were: Hammermill Copy Plus (HCP), Xerox 4024 (X4024) and Hewlett Packard office paper (Hpoff).

Optical Density - Ink with and without Hydrosol

| Paper | Ink A | Ink 1 | Ink 2 |
|---|---|---|---|
| HCP | 1.33 | 1.37 | 1.34 |
| Hpoff | 1.30 | 1.31 | 1.29 |
| X4024 | 1.23 | 1.31 | 1.32 |
| Average | 1.29 | 1.33 | 1.32 |

Optical Density - Ink with and without soluble binder

| Paper | Ink D | Ink E |
|---|---|---|
| HCP | 1.37 | 1.34 |
| Hpoff | 1.37 | 1.26 |
| X4024 | 1.40 | 1.35 |
| Average | 1.38 | 1.32 |

Optical Density results show that addition of the hydrosol (inks 1 and 2) increases OD relative to ink without binder (Ink A), whereas an in with soluble polymer (Ink E) lowers OD as compared to a similar ink without such polymer (Ink D).

The inventive inks were further tested for smear resistance on Hammermill Copy Plus Paper. The results, summarized in the following table, demonstrate the inventive inks are effective at reducing smear compared to ink without any binder.

Smear Evaluation (milli-OD units)

| Highlighter Marker | Ink A | Ink 1 | Ink 2 |
|---|---|---|---|
| Acidic | 120 | 50 | 30 |
| Basic | 130 | 30 | 30 |

### Example 2

The inks from Example 1 were further tested by draw down on Hammermill Copy Plus using a #3 rod. Optical density was measured as before and are summarized in the following table.

Draw Down on HCP paper

| Ink | Optical Density |
|---|---|
| Ink A | 1.12 |
| Ink 1 | 1.16 |
| Ink 2 | 1.14 |
| Ink D | 1.09 |
| Ink E | 1.06 |

This example reconfirms the findings of the previous example. Also, it demonstrates the beneficial results obtained for the inventive inks are independent of the printer used to jet the ink.

### Example 3

Additional inks were prepared according to the recipes shown in the following table. Values are in weight percent of the final weight. Pigment was added as the dispersion.

| | Ink Formulation | | |
|---|---|---|---|
| Ingredients | Ink F* | Ink 3 | Ink 4 |
| Dispersion 1 (as % pigment) | 3.0 | 3.0 | 3.0 |
| Trimethylol propane | 4.0 | 4.0 | 4.0 |
| Glycerol | 10.0 | 10.0 | 10.0 |
| Diethylene glycol | 5.0 | 5.0 | 5.0 |
| 2-pyrrolidone | 3.0 | 3.0 | 3.0 |
| Surfynol ® 465 | 0.2 | 0.2 | 0.2 |
| Hydrosol 1 (as % polymer) | — | 0.75 | — |
| Hydrosol 2 (as % polymer) | — | — | 0.75 |
| Water (balance to 100%) | bal | bal | bal |

*Comparative Example

Inks were tested by draw down on Hammermill Copy Plus and Xerox 4024 papers using a #3 rod. Optical density results are summarized in the following table.

Optical Density Results

| Paper | Ink F | Ink 3 | Ink 4 |
|---|---|---|---|
| HCP | 1.24 | 1.36 | 1.28 |
| X4024 | 1.29 | 1.37 | 1.31 |
| Average | 1.26 | 1.37 | 1.30 |

This example demonstrates an additional hydrosol and a different vehicle compared to previous examples. Again, the inventive inks containing hydrosol provide higher optical density than similar ink without hydrosol.

The two inks with hydrosol both have higher optical densities than the comparative ink with no such polymer.

1. An aqueous inkjet ink comprising a self-dispersing pigment colorant, an aqueous vehicle and a hydrosol polymer.

2. The aqueous inkjet ink of claim 1, comprising:
(a) about 0.01% to about 10% self-dispersing pigment colorant,
(b) about 70% to about 99.8% aqueous vehicle, and
(c) about 0.1 % to about 20% (solids) hydrosol polymer, by weight based on the total weight of the ink.

3. The aqueous inkjet ink of claim 1, wherein the hydrosol polymer is an acrylic hydrosol polymer.

4. The aqueous inkjet ink of claim 1, wherein the self-dispersing pigment colorant has at least one type of hydrophilic functional group bonded onto a surface of the self-dispersing pigment colorant, the at least one type of hydrophilic functional group comprising a carboxyl group, and having a degree of functionalization of less than about 3.5 μmol/m².

5. The aqueous inkjet ink of claim 1, wherein the self-dispersing pigment colorant is a carbon black.

6. The aqueous inkjet ink of claim 1, further comprising about 0.1% to about 2% of a soluble structured polymer.

7. The aqueous ink jet ink of claim 1, having a surface tension in the range of about 20 mN/m to about 70 mN/m at 25° C., and a viscosity up to about 30 mPa.s at 25° C.

8. An ink set comprising at least three differently colored inks, wherein at least one of the inks is an aqueous inkjet ink comprising a self-dispersing pigment colorant, an aqueous vehicle and a hydrosol polymer.

9. The ink set of claim 8, wherein the aqueous inkjet ink comprises:
(a) about 0.01% to about 10% self-dispersing pigment colorant,
(b) about 70% to about 99.8% aqueous vehicle, and
(c) about 0.1% to about 20% (solids) hydrosol polymer, by weight based on the total weight of the ink.

10. The ink set of claim 8, wherein the hydrosol polymer in the aqueous inkjet ink is an acrylic hydrosol polymer.

11. The ink set of claim 8, wherein the self-dispersing pigment colorant in the aqueous inkjet ink has at least one type of hydrophilic functional group bonded onto a surface of the self-dispersing pigment colorant, the at least one type of hydrophilic functional group comprising a carboxyl group, and having a degree of functionalization of less than about 3.5 μmol/m².

12. The ink set of claim 8, wherein the self-dispersing pigment colorant in the aqueous inkjet ink is a carbon black.

13. The ink set of claim 8, wherein the aqueous inkjet ink further comprising about 0.1% to about 2% of a soluble structured polymer.

14. The ink set of claim 8, wherein the aqueous ink jet ink has a surface tension in the range of about 20 mN/m to about 70 mN/m at 25° C., and a viscosity up to about 30 mPa.s at 25° C. as set forth in any one of claims 1-7.

15. The ink set of claim 8, comprising at least four differently colored inks, wherein at least one of the inks is an aqueous ink jet ink comprising a self-dispersing black pigment colorant, an aqueous vehicle and a hydrosol polymer.

16. A method for ink jet printing onto a substrate, comprising the steps of:
(a) providing an ink jet printer that is responsive to digital data signals;
(b) loading the printer with a substrate to be printed;
(c) loading the printer with an aqueous inkjet ink comprising a self-dispersing pigment colorant, an aqueous vehicle and a hydrosol polymer; and
(d) printing onto the substrate using the ink or inkjet ink set in response to the digital data signals.

17. A method for ink jet printing onto a substrate, comprising the steps of:
(a) providing an ink jet printer that is responsive to digital data signals;
(b) loading the printer with a substrate to be printed;
(c) loading the printer with an ink set comprising at least three differently colored inks, wherein at least one of the inks is an aqueous inkjet ink comprising a self-dispersing pigment colorant, an aqueous vehicle and a hydrosol polymer; and
(d) printing onto the substrate using the ink or inkjet ink set in response to the digital data signals.
